(19) United States
(12) Patent Application Publication
(10) Pub. No.: US 2026/0292687 A1
(43) Pub. Date: Sep. 24, 2026

(54) CHANNEL STATE INFORMATION FEEDBACK USING VARIOUS WAVEFORMS

(71) Applicant: QUALCOMM Incorporated, San Diego, CA (US)

(72) Inventors: Jung Ho RYU, Englewood Cliffs, NJ (US); Jelena DAMNJANOVIC, Del Mar, CA (US); Junyi LI, Greentown, PA (US); Igor GUTMAN, Hod HaSharon (IL); Tao LUO, San Diego, CA (US)

(21) Appl. No.: 19/083,338

(22) Filed: Mar. 18, 2025

(51) Int. Cl. H04W 52/02

(52) U.S. Cl. CPC H04W 52/0235

(57) ABSTRACT

Certain aspects of the present disclosure provide techniques for wireless communications. An example method includes receiving, from a network entity, a signal; generating a set of channel state information (CSI) feedback parameters based on the signal; generating a sequence associated with a waveform having a threshold autocorrelation property; and transmitting the waveform in accordance with the sequence, the sequence having a cyclic shift size, wherein the cyclic shift size indicates a first CSI feedback parameter selected from the set of CSI feedback parameters, the set of CSI feedback parameters comprising a reference signal received power (RSRP) parameter, a synchronization signal/physical broadcast channel (SS/PBCH) block resource indicator (SSBRI) parameter, or a CSI reference signal resource indicator (CRI) parameter.

### INTRODUCTION

### Field of the Disclosure

Aspects of the present disclosure relate to wireless communications, and more particularly, to techniques for channel state information (CSI) feedback using various waveforms.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE), the UE capable of operating in a low-power transceiver mode, the method includes receiving, from a network entity, a signal; generating a set of channel state information (CSI) feedback parameters based on the signal; generating a sequence associated with a waveform having a threshold autocorrelation property; and transmitting the waveform in accordance with the sequence, the sequence having a cyclic shift size, wherein the cyclic shift size indicates a first CSI feedback parameter selected from the set of CSI feedback parameters, the set of CSI feedback parameters comprising a reference signal received power (RSRP) parameter, a synchronization signal/physical broadcast channel (SS/PBCH) block resource indicator (SSBRI) parameter, or a CSI reference signal resource indicator (CRI) parameter.

Certain aspects provide a method for wireless communications by a UE, the UE capable of operating in a low-power transceiver mode, the method includes receiving, from a network entity, a signal; generating a set of CSI feedback parameters based on the signal; mapping the set of CSI feedback parameters to a first set of subcarriers of a CSI feedback signal, the set of CSI feedback parameters comprising one or more SSBRI parameters, one or more CSI reference signal resource indicator (CRI) parameters, or one or more RSRP parameters; applying first signal power to a subcarrier of the first set of subcarriers, wherein the subcarrier corresponds to a selected first CSI feedback parameter of the set of CSI feedback parameters; and transmitting a waveform in accordance with the CSI feedback signal.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of a UE architecture that supports low power transceiver and main transceiver configurations.

FIG. 6 depicts example low power signals that may be received by a low power transceiver of a UE.

FIG. 7 depicts example communications signaling for a channel state information (CSI) report that may be transmitted by a UE.

FIG. 8 depicts a first example of a waveform construction technique that may be used by a UE to transmit waveforms.

FIG. 9 depicts a second example of a waveform construction technique that may be used by a UE to transmit waveforms.

FIG. 10 depicts a method for wireless communications.

FIG. 11 depicts another method for wireless communications.

FIG. 12 depicts aspects of an example communications device.

### DETAILED DESCRIPTION

Aspects of the present disclosure provide apparatuses, methods, processing systems, and computer-readable mediums for channel state information (CSI) feedback using various waveforms.

Low power receivers are used in various devices, such as a user equipment (UE), to minimize energy consumption while maintaining the ability to receive signals. A low power receiver may remain in a deep sleep state to consume minimal power and periodically wake up, for example, at predetermined times, to check if there are any incoming signals for the UE. The signals that a low power receiver is capable of receiving may be different than the various signals that a main receiver of the UE is capable of receiving.

For example, a UE may employ a low-power wake-up receiver (LP-WUR) that uses very low power and remains operational during most or all of the time that the main receiver and/or main system of the UE sleep. The LP-WUR may receive a low-power wake-up signal (LP-WUS) from the network, thereby causing the UE to wake up and become fully or near fully operational again. However, when the UE wakes up after sleeping, the wireless channel may have changed, and the main receiver may experience difficulty decoding the control and data signals from the network. Thus, in some deployments, the UE may perform and report channel estimation, frequency tracking, or the like, while in low power mode.

Accordingly, the UE may perform a CSI process using a LP-WUR or a low-power transmitter (LP-Tx). For example, the LP-WUR or the main receiver(s) of the UE may receive CSI reference signals (CSI-RS) transmitted by the network. The CSI-RS are used for wireless channel measurement purposes by the UE.

The UE measures the wireless channel conditions using the received CSI-RS and may generate a CSI report containing various parameters. The parameters and information in the CSI report may include any one or more of: a channel quality indicator (CQI) for providing information about the overall channel quality; a precoding matrix indicator (PMI) for suggesting an optimized precoding matrix for the network to use for transmissions; a rank indicator (RI) for indicating the number of layers that can be supported; a layer indicator (LI) for indicating the strongest layer from the number of layers indicated by the RI; a reference signal received strength (RSRP); a synchronization signal/physical broadcast channel (SS/PBCH) block resource indicator (SSBRI); or a CSI-RS resource indicator (CRI).

By performing the CSI process, the UE may provide the network with up-to-date CSI, thereby allowing the optimized resource allocation and transmission parameters to be set by the network. Furthermore, by performing the CSI process using the LP-WUR or the LP-Tx while in the low-power mode, the UE may simplify or speed up transitioning from a low power mode to a full power mode for the main receiver. However, an LP-Tx may have limited processing, memory, and/or transmission capabilities relative to a main transceiver of a UE. For example, an LP-Tx may perform sequence-based transmissions whereas a main transceiver may perform more complex transmissions using sophisticated modulation, coding, precoding, or the like. Therefore, techniques for generation and transmission of a CSI report via a main transceiver may exceed capabilities of the LP-Tx, with regard to supported transmission types, memory usage, or processor usage, thereby impeding usage of the LP-Tx for CSI reporting in the low power mode. Furthermore, certain parameters of a CSI report for a main transceiver may be difficult or impossible to determine using an LP-WUR, thereby further impeding CSI generation and reporting in the low-power mode.

Various aspects described herein may overcome the aforementioned technical problems associated with LP-WUR operations, for example, by providing CSI feedback using various waveforms while a UE is operating in a low-power transceiver mode. In some aspects, the UE may transmit waveforms based on sequences to communicate CSI feedback parameters. For example, a sequence may be used to generate a waveform corresponding to a given CSI feedback parameter or set of CSI feedback parameters, and the UE may transmit the sequence (while in the low-power transceiver mode) to indicate the corresponding CSI feedback parameter(s). In some aspects, when the sequence used to generate waveforms has a low threshold autocorrelation property, additional CSI feedback parameter(s) may be conveyed, for example, by cyclic shifting the resulting sequences. In some aspects, the UE may transmit waveforms based on CSI feedback signals to communicate the CSI feedback parameters. For example, a CSI feedback signal may have certain subcarriers mapped to corresponding CSI feedback parameters, and the UE may transmit a signal with a selected set of subcarriers to indicate a corresponding set of CSI feedback parameters.

The techniques for sending CSI feedback using various waveforms described herein may provide various beneficial technical effects and/or advantages. For example, by sending CSI reports to the network while remaining in the low-power transceiver mode, the UE saves power while at the same time enabling the UE to effectively remain in LP-WUS coverage area while in motion. Additionally, the disclosed techniques overcome a challenge with regard to how the UE can send the CSI report while in the low-power transceiver mode. For example, while a typical LP-WUR has no transmitting capability, the low-power transceiver has some limited transmitting capabilities with respect to processor complexity, allocated memory, power availability, etc. By storing a number of pre-generated waveforms and/or preprocessed signals from sequences or signals in memory, the UE may use these pre-generated waveforms to transmit the CSI reports while in the low-power transceiver mode, thereby minimizing the complexity and computing resources required to perform the CSI reporting procedures.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

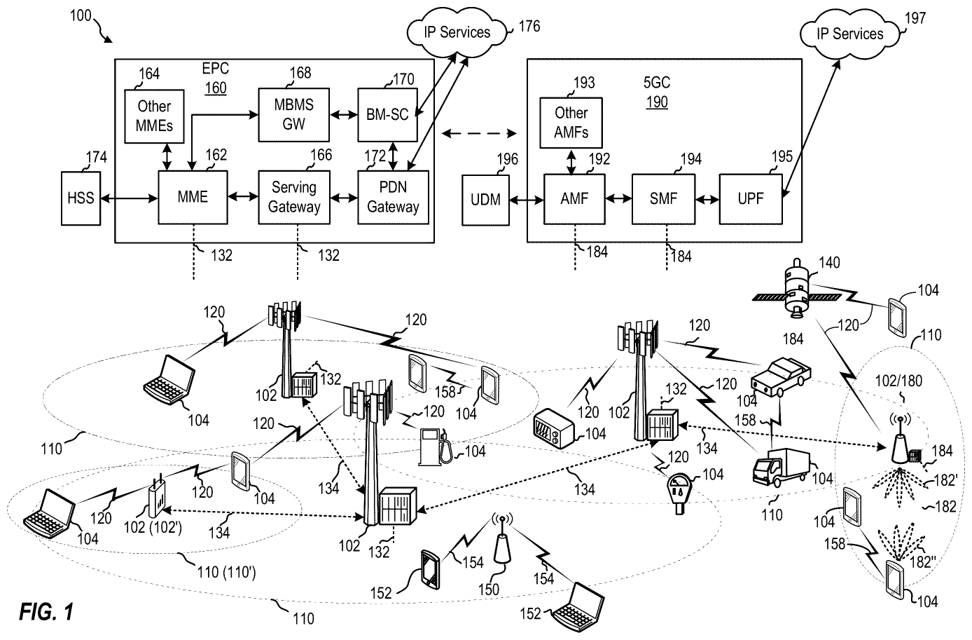

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

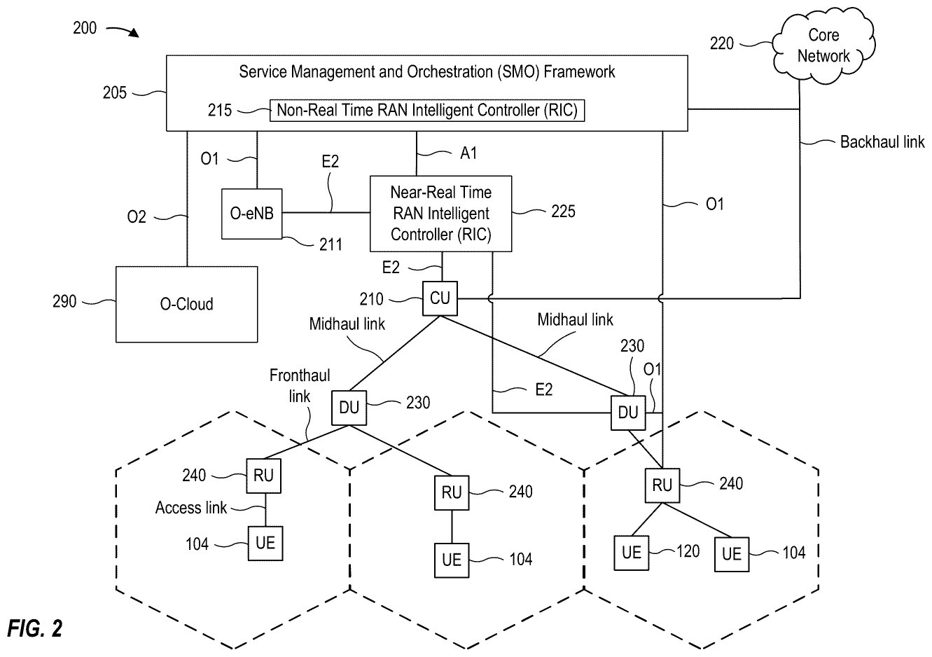

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

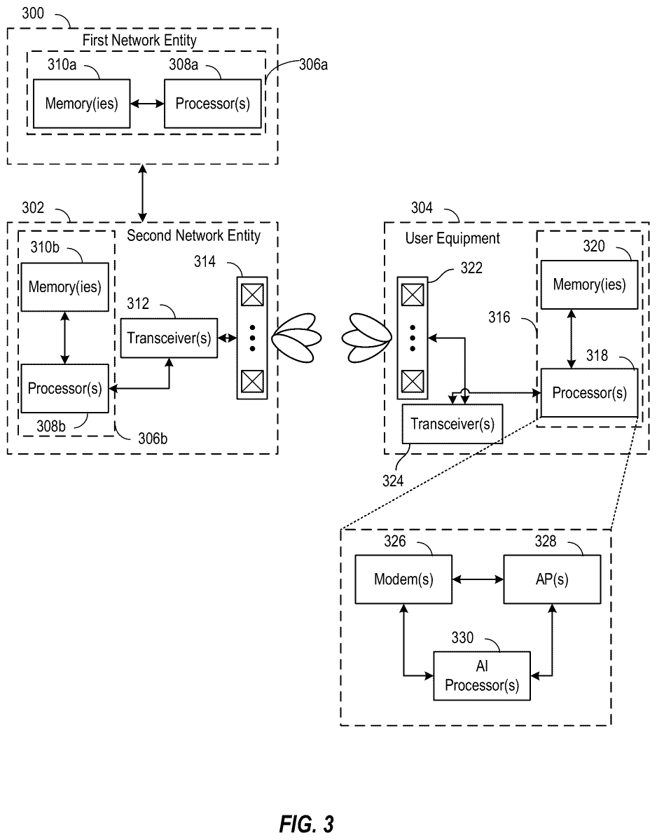

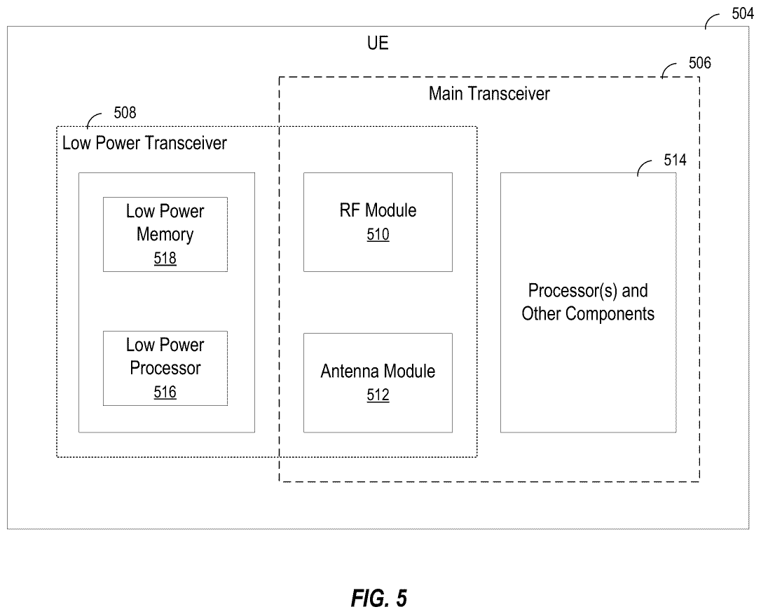

FIG. 3 depicts aspects of network entities 300 and 302 and a UE 304. In some aspects, the UE 304 may have a main transceiver 506 and a low power transceiver 508, described in more detail in connection with FIG. 5

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

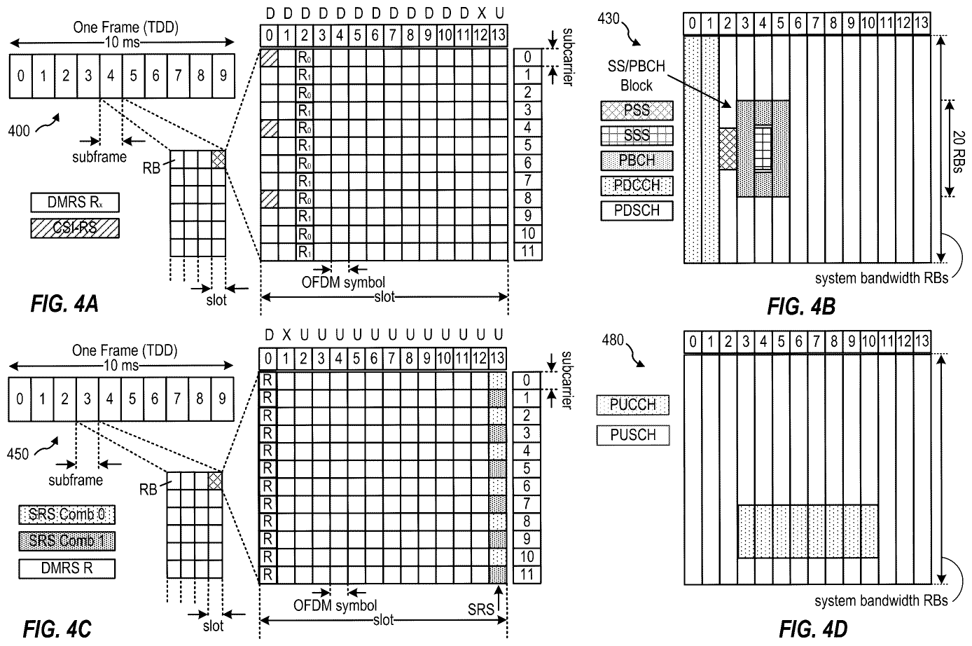

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to UE Architecture for Supporting CSI Feedback Using Various Waveforms

FIG. 5 depicts an example 500 of a UE architecture that supports low power transceiver and main transceiver configurations. The example 500 illustrates UE 504, which may be an example of UE 104 depicted and described with respect to FIG. 1, or the UE 304 depicted and described with respect to FIG. 3. In some aspects, the UE 504 may be another type of a UE or a wireless communications device, such as those referenced and described herein.

As depicted, the UE 504 has two transceivers-a main transceiver 506 and a low power transceiver 508. The main transceiver 506 and the low power transceiver 508 may share some components, such as radio frequency (RF) module 510 and antenna module 512, for example, to reduce the cost of the UE 504. These shared components may be used by the low power transceiver 508 at reduced capabilities, for example, to further decrease power use by the UE 504. In certain implementations, the main transceiver 506 and the low power transceiver 508 may be implemented for a same modem and use a same protocol stack.

The main transceiver 506 includes or utilizes processor(s) and other components 514. The other components may include one or more memories that may be coupled to one or more processors. The UE 504 may switch off the one or more processors and other components of the main transceiver 506.

As depicted, the low power transceiver 508 includes or utilizes a low power (e.g., limited) processor 516 and a low power (e.g., limited) memory 518. In some aspects, the one or more processors and one or more memories included in the low power processor 516 and low power memory 518 may be examples of or configurations of, respectively, the one or more processors 318 and the one or more memories 320 described with respect to FIG. 3. The low power processor 516 may be less complex and/or may use less power than the one or more processors included in the processor(s) and other components 514 used for the main transceiver 506. In some aspects, the one or more processors and one or more memories included in the processor(s) and other components 514 may be examples of or configurations of, respectively, the one or more processors 318 and the one or more memories 320 described with respect to FIG. 3.

The low power processor 516, as a part of low power transceiver 508, has limited, simple capabilities, including frequency and time synchronization, RSRP measurements, etc. To implement power saving advantages, the low power transceiver 508 may store signal representations to effectuate signal transmission in the low power memory 518. The low power memory 518 may also be an example or the one or more memories 320 described with respect to FIG. 3.

These signal representations correspond to pre-generated and/or preprocessed signals from a sequence or base signal, and stored in the low power memory 518 as a waveform construct (e.g., store in-phase and quadrature (I/Q) samples as complex numbers). The pre-generated and/or preprocessed signals stored in the low power memory 518 may be sent directly to the RF module 510 and antenna module 512 for transmission. That is, for example, pre-generated and/or preprocessed signals and waveforms are those that have been created and stored in advance, rather than being generated on demand. It is to be appreciated that the waveforms based on a sequence (e.g., a Zadoff Chu (ZC) sequence, m-sequence, etc.) or base signal (e.g., CSI feedback signal) to be transmitted using the low power transceiver 508 have simple enough constructs to be pre-generated and stored in the low power memory 518, in accordance with certain implementations. Thus, these waveforms may be transmitted without activating the processor(s) and other components 514.

When operating in a low-power transceiver mode, the UE 504 may deactivate the main transceiver 506 and/or the processor(s) and other components 514, thereby saving power. In the low-power transceiver mode, the low power transceiver 508 may be operational and provide CSI feedback for the UE 504 using the capabilities afforded by the low power processor 516 and the low power memory 518.

In some implementations, however, the main transceiver 506 and the low power transceiver 508 may be implemented as power configuration modes (e.g., a main-power transceiver mode and a low-power transceiver mode) using the same transceiver components (e.g., processor(s) and other components 514 may include the low power processor 516 and the low power memory 518), not as depicted in FIG. 5. In this manner, the UE 504 may operate in different power configuration modes rather than using different transceiver circuitry to effectuate the low-power transceiver mode.

### Aspects Related to Low Power Signals

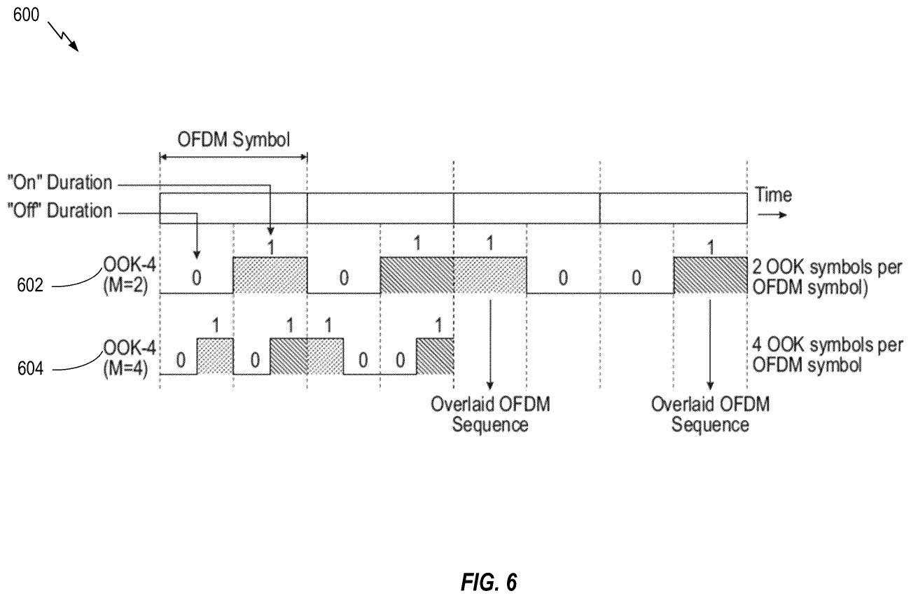

FIG. 6 depicts examples 600 of low power signals that may be received by a low power transceiver of a UE. The low power signals are on-off keying (OOK) waveforms that may be used for LP-WUS and low-power synchronization signal (LP-SS). Specifically, OOK-1 and/or OOK-4 may be used for LP-WUS and LP-SS transmission to UEs.

From the baseband perspective, an OOK waveform is a sequence of high power/amplitude (or ON) durations or low (or zero) power/amplitude (or OFF) durations, as depicted in FIG. 6. These high/low durations may be used to convey an information bit. For LP-WUS, the OOK waveform may include 11 PRBs with an SCS of 30 KHz for transmissions in FR1. According to some aspects, the low power transceiver of a UE may be capable of receiving and transmitting OFDM symbols.

An OOK-1 waveform may convey one bit of information in one OFDM symbol, whereas an OOK-4 waveform may convey M bits of information in one OFDM symbol. As depicted, a first OOK signal 602 corresponds to an OOK-4 (M=2) waveform with two OOK symbols per OFDM symbol. A second OOK signal 604 corresponds to an OOK-4 (M=4) waveform with four OOK symbols per OFDM symbol. In accordance with some aspects, a Gold sequence, an m-sequence, a computer searched sequence, or a ZC sequence may be used as an overlaid OFDM sequence for OOK waveforms.

### Example Signaling of CSI Feedback Using Various Waveforms

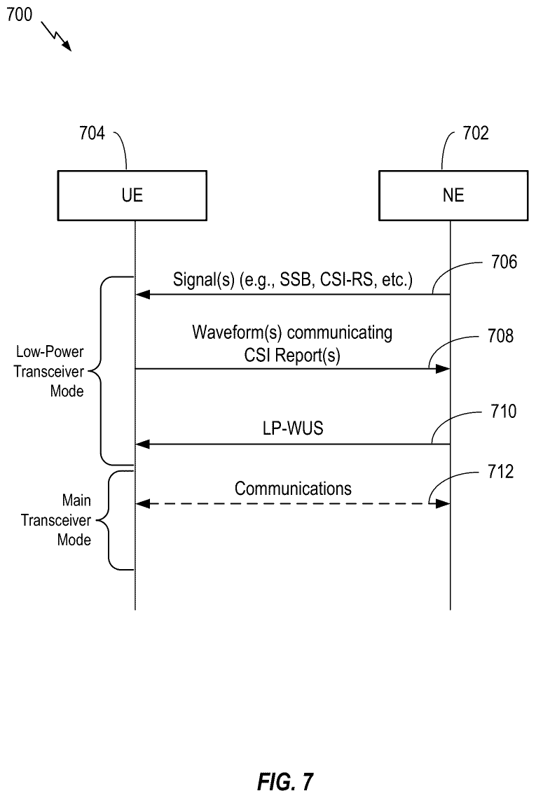

FIG. 7 depicts example communications signaling 700 for a CSI report that may be transmitted by a UE 704. The example communications signaling 700 may be between a network entity 702 and the UE 704.

In some aspects, the network entity 702 may be an example of the BS 102 depicted and described with respect to FIG. 1, the first network entity 300 or the second network entity 302 depicted and described with respect to FIG. 3, a disaggregated base station depicted and described with respect to FIG. 2. Similarly, the UE 704 may be an example of UE 104 depicted and described with respect to FIG. 1, or the UE 304 depicted and described with respect to FIG. 3. The UE 704 may employ the UE architecture that supports low power transceiver and main transceiver configurations, as depicted and described with respect to FIG. 5. In some aspects, the network entity 702 may be another type of a network entity, a network node, or a network, such as those referenced and described herein. The UE 704 may be another type of a UE or a wireless communications device, such as those referenced and described herein.

At 706, the network entity 702 may send, and the UE 704 may receive, a signal(s). The signal(s) may be an SSB, CSI-RS, etc., in the downlink. The signal(s) may be used by the UE 704 to measure the channel conditions and compute CSI feedback parameters while the UE 704 is operating in the low-power transceiver mode. Because the UE 704 is operating in the low-power transceiver mode and may be using a low power transceiver to measure the signal(s), the CSI feedback parameters to be determined by the UE 704 are aligned with the measurement capabilities of the low-power transceiver mode and/or the low power transceiver.

The UE 704 may be in motion while operating in the low-power transceiver mode. Additionally, or alternatively, the channel condition may be changing while operating in the low-power transceiver mode, which may be for an extended duration in certain operational scenarios. Moreover, the SSB, CSI-RS, etc., may be transmitted periodically or aperiodically, depending on the configuration by the network entity 702. For example, periodic CSI-RS may be used for regular channel measurements, and the UE 704 may be configured to periodically provide a CSI report. For example, the UE 704 may be configured to send CSI reports periodically via PUCCH resources. The CSI report may be used by the network entity 702 to determine downlink transmission parameters, including but not limited MCS, channel coding rate, transmit beams, etc.

When UE 704 is operating in a low power or low-power transceiver mode, for example, while monitoring for an LP-WUS as a wake up indication from the network entity 702, the UE 704 may send a CSI report using a low power transceiver and/or while operating in a low-power transceiver mode. In some aspects, the CSI report may include one or more CSI feedback parameters. For example, the CSI report may include a CQI, a PMI, an RI, an LI, an RSRP, an SSBRI, and/or a CRI. However, because waveforms are used to convey the CSI reports, the amount of information in a given CSI report may be reduced relative to a CSI report in a full power mode, in accordance with some aspects.

For example, the waveforms may convey an SSBRI, which indicates the specific SSB resource index that UE 704 used for CSI measurements and reporting. The waveforms may also convey a CRI, which indicates a preferred beam, or a specific CSI-RS resource, that the UE 704 has identified as having better channel conditions for data transmission. The waveforms may also convey RSRP, which indicates the average power received from a resource allocated to a reference signal being measured for CSI purposes (e.g., SSB, CSI-RS, etc.). In some cases, the RSRP measurements may be generated at Layer 1 and/or Layer 3. The RSRP of a resource may be used for mobility, power control calculations, and/or beam management, in accordance with some aspects.

At 708, the UE 704 may send, and the network entity 702 may receive, a waveform communicating a CSI report while the UE 704 is operating in a low-power transceiver mode. For example, the UE 704 may generate CSI feedback parameters based on the signal(s) received from the network entity 702 also while the UE 704 is operating in the low-power transceiver mode. In some aspects, the UE 704 may send multiple waveforms corresponding to multiple CSI reports during the time the UE 704 is operating in the low-power transceiver mode. The UE 704 may be capable of transmitting various types of waveforms for communicating these CSI feedback parameters in the CSI report to the network entity 702.

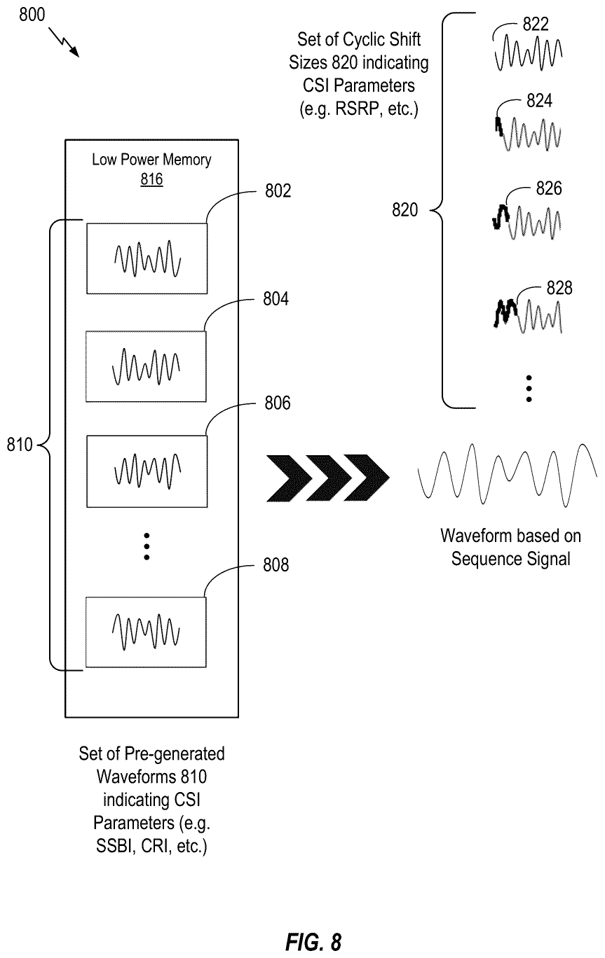

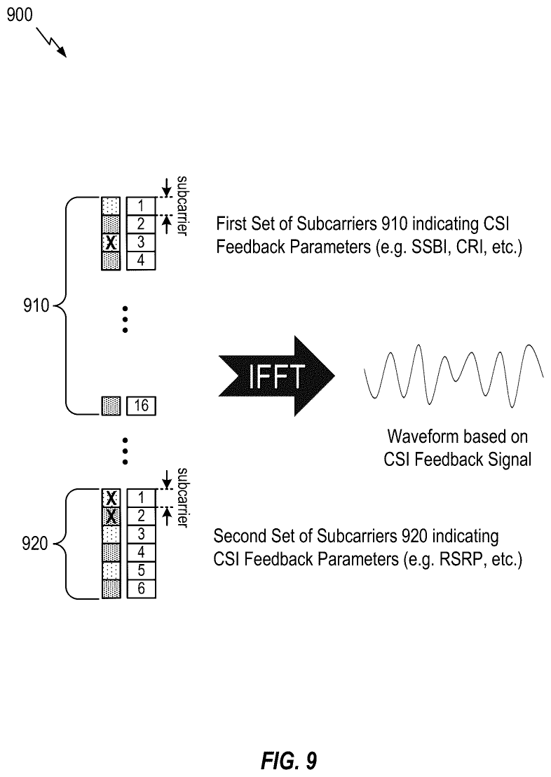

In some examples, the UE 704 may transmit a waveform in accordance with a sequence as described herein, including the examples depicted and described with respect to FIG. 8. For example, the UE 704 may transmit the waveform in accordance with a ZC sequence or an m-sequence. In some examples, the UE 704 may transmit a waveform in accordance with a CSI feedback signal as described herein, including the examples depicted and described with respect to FIG. 9. Multiple CSI reports may be sent with plural waveforms to communicate various combinations of the CSI feedback parameters determined by the UE 704. For example, a CRI i₁ and an associated RSRP r₁ may be mapped to a first waveform communicating a first CSI report, a CRI i₂ and RSRP r₂ may be mapped to a second waveform communicating a second CSI report, etc.

In some implementations, the UE 704 may pre-generate and store multiple mapped waveforms in the low power memory associated with the UE's low-power transceiver circuitry and architecture. While in the low-power transceiver mode, the UE 704 may select a pre-generated waveform that represents the CSI report and UE 704 transmits the pre-generated to the network entity 702.

At 710, the network entity 702 may send, and the UE 704 may receive, an LP-WUS. At least some transmission parameters of the LP-WUS may be based on the CSI report(s) sent by the UE 704. For example, the network entity 702 may change a transmit beam for transmitting the LP-WUS. In this manner, the UE 704 may be more likely to remain in the LP-WUS coverage area of the network entity 702 while the UE 704 is in motion. In some cases, the LP-WUS may provide an indication to the UE 704 that the UE 704 is to transmit another CSI report while remaining in the low-power transceiver mode, for example, before switching out of the low-power transceiver mode to a main transceiver mode. In this manner, the network entity 702 may obtain a recent CSI report and effectively communicate with the UE 704 in the main transceiver mode upon initially waking up the main transceiver and/or circuitry of the main transceiver mode.

In accordance with some aspects, the UE 704 includes a low power transceiver that can both (i) receive, demodulate, and decode an LP-WUS, and (ii) encode, modulate, and transmit a waveform communicating CSI feedback parameters. At 712, the UE 704 and the network entity 702 may communicate while the UE 704 is operating in the main transceiver mode.

Note that the process flow illustrated in FIG. 7 is an example of signaling of CSI feedback using various waveforms. Note that the process flow illustrated in FIG. 7 is described herein to facilitate an understanding of CSI reports that may be transmitted using various waveforms, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

### Example Waveform Construction Techniques

FIG. 8 depicts a first example 800 of a waveform construction technique that may be used by a UE (e.g., UE 704) to transmit waveforms.

For transmitting waveforms in accordance with a sequence, the UE may be configured with a sequence length of a Zadoff-Chu (ZC) sequence. The sequence length is denoted as N_{ZC}. The root sequence index is denoted as u. To generate a ZC sequence, u and N_{ZC} are relatively prime. That is, for example, if N_{ZC} is a prime number, then u=1, 2, . . . , N_{ZC}−1 are relatively prime with N_{ZC}.

Thus, a ZC sequence may be generated based on the following equation:

$$ZC sequence {x}_{u} ( m ) = \{ \begin{matrix}{e}^{- j \frac{{num}^{2}}{{N}_{ZC}}} & if {N}_{ZC} is even \\ {e}^{- j \frac{num ( m + 1 )}{{N}_{ZC}}} & if {N}_{ZC} is odd\end{matrix} \qquad ( Eq . 1 )$$

In some examples, each CSI feedback parameter and a set of values corresponding to each CSI feedback parameter may be mapped to a root sequence index, u. For example, with respect to the SSBRI parameter, the values of this parameter may be mapped as follows. SSBRI 0 may be mapped to a first root sequence index, u=1, SSBRI 1 may be mapped to a second root sequence index, u=2, SSBRI 2 may be mapped to a third root sequence index, u=3, . . . , and SSBRI 15 may be mapped to a sixteenth root sequence index, u=16.

Additionally, or alternatively, the CRI parameter may be conveyed. For example, with respect to the CRI parameter, the values of this parameter may be mapped as follows. CRI 0 may be mapped to the first root sequence index, u=1, CRI 1 may be mapped to the second root sequence index, u=2, CRI 2 may be mapped to the third root sequence index, u=3, . . . , and CRI 15 may be mapped to the sixteenth root sequence index, u=16. In some examples, SSBRI 0 may be mapped to the first root sequence index, u=1, SSBRI 1 may be mapped to the second root sequence index, u=2, . . . , SSBRI 15 may be mapped to the sixteenth root sequence index, u=16, CRI 0 may be mapped to a seventeeth root sequence index, u=17, CRI 1 may be mapped to an eighteenth root sequence index, u=18, . . . , and CRI 15 may be mapped to a thirty-second sequence index, u=32.

Additionally, the autocorrelation of ZC sequence with a cyclically shifted version of itself is zero or near zero. Accordingly, a generated unique ZC sequence may be cyclically shifted prior to transmission, in accordance with some aspects. That is, for example, ZC sequences have a low threshold autocorrelation property. Also, when plotted in the time domain, ZC sequences may exhibit characteristics of constant amplitude. Thus, the waveforms generated by a ZC sequence may be categorized as constant amplitude zero autocorrelation (CAZAC) waveforms. Sequences like the ZC sequence that generate CAZAC waveforms may be used in low power/low complexity transceivers due to the properties of these waveforms having constant amplitude and zero or near-zero autocorrelation off the direct current (DC) component.

In some examples, for transmitting waveforms in accordance with a sequence, the UE may be configured with an 1-stage shift register when an m-sequence scheme is used to shape waveforms. The 1-stage shift register is a linear feedback shift register (LFSR) with ‘l’ stages. Each stage can hold a binary value (0 or 1), and the output of certain stages is fed back into the input through XOR gates to create a feedback loop for sequence generation purposes. The length of an m-sequence generated by an l-stage shift register is 2^{l}−1.

To generate an m-sequence from the l-stage shift register, feedback taps of the l-stage shift register correspond to a primitive polynomial. The primitive polynomial ensures that the sequence has the maximum possible length. A polynomial f(x) over the Galois field GF(2) is considered primitive (i.e., a primitive polynomial) if the polynomial is irreducible and its roots generate the cyclic multiplicative group of the extension field GF(2^{k}), where k is defined as the degree of the polynomial. That is, for example, a primitive polynomial ensures that the 1-stage shift register cycles through all possible non-zero states, producing an m-sequence.

In some examples, each CSI feedback parameter may be mapped to a primitive polynomial. For example, SSBRI 0 may be mapped to a first primitive polynomial, SSBRI 1 may be mapped to a second primitive polynomial, SSBRI 2 may be mapped to a third primitive polynomial, . . . , and SSBRI 15 may be mapped to a sixteenth primitive polynomial.

Additionally, or alternatively, CRI 0 may be mapped to the first primitive polynomial, CRI 1 may be mapped to the second primitive polynomial, CRI 2 may be mapped to the third primitive polynomial, . . . , and CRI 15 may be mapped to the sixteenth primitive polynomial. In some examples, SSBRI 0 may be mapped to the first primitive polynomial, SSBRI 1 may be mapped to the second primitive polynomial, . . . , SSBRI 15 may be mapped to the sixteenth primitive polynomial, CRI 0 may be mapped to a seventieth primitive polynomial, CRI 1 may be mapped to an eighteenth primitive polynomial, . . . , and CRI 15 may be mapped to a thirty-second primitive polynomial.

Like ZC sequences, m-sequences typically have excellent autocorrelation properties. Accordingly, a generated unique m-sequence may further be cyclically shifted prior to transmission, in accordance with some aspects. A threshold autocorrelation property may provide autocorrelation that is lower than a threshold, such as a threshold at which cyclic shifting of such a sequence is enabled without undue correlation.

The root sequence index, u, (as used in ZC sequence generation) and the primitive polynomial (as used in m-sequence generation) may be generally described as sequence generation parameters. That is, for example, each sequence generation parameter for a particular sequence scheme is used to generate a unique sequence of the same length for that particular sequence scheme. Each sequence generation parameter for the particular sequence scheme may be mapped to a corresponding CSI feedback parameter.

As depicted, a set of pre-generated waveforms 810 may be stored in the low power memory 816 of a UE. In some examples, the low power memory 816 may be, or include aspects of, a low power memory 518, described in more detail in connection with FIG. 5. Based on the determined sequence generation parameter (e.g., root sequence index, primitive polynomial, etc.) for communicating a CSI feedback parameter, the UE may select a waveform for transmission from a first pre-generated waveform 802, a second pre-generated waveform 804, a third pre-generated waveform 806, and an n^{th} pre-generated waveform 808. In some examples, these waveforms may generated by the UE as needed.

In this manner, the waveform transmitted in accordance with the generated unique sequence is detectable as a unique waveform by a network entity (e.g., network entity 702, other receiving device, etc.). Thus, the network entity can determine the sequence generation parameter (e.g., root sequence, primitive polynomial, etc.) used for the received unique waveform. The network entity then identifies what CSI feedback parameter is being reported by the UE based on the mapping between the sequence generation parameter and the CSI feedback parameter.

Additionally, or alternatively, a cyclic shift may be applied to the unique sequence of the same length for that particular sequence scheme. For example, additional sequences may be generated from a ZC sequence by applying cyclic shifts thereto. These additionally generated sequences have the same constant amplitude and autocorrelation properties as the root sequence from which these sequences were generated. The number of sequences per root sequence may be equal to the sequence length, N_{ZC}, divided by the size of the cyclic shift. For example, if N_{ZC}=16 and the cyclic shift size=1, the number of sequences per root sequence is 16.

As depicted, a set of cyclic shift sizes 820 may be applied to the selected pre-generated waveform. In some examples, each cyclically shifted waveform for each generated waveform may be stored in the low power memory 816 of the UE. In some examples, at least some information for applying each cyclic shift size to a pre-generated waveform may be stored in the low power memory 816 of the UE. In some examples, the cyclic shift sizes may be applied by the UE as needed. After selecting a pre-generated waveform from the set of pre-generated waveforms 810, the UE may determine which cyclic shift size to apply to the pre-generated waveform. Based on the determined cyclic shift size for communicating a CSI feedback parameter, the UE may select no cyclic shift 822, a first cyclic shift size 824, a second cyclic shift size 826, a third cyclic shift size 828, etc., from the set of cyclic shift sizes 820 to apply to the selected pre-generated waveform.

In some examples, each CSI feedback parameter may be mapped to a cyclic shift size. The RSRP parameter may specify a value or range of values when conveyed. For example, an RSRP value between 0 dBm and −2 dBm may be mapped to cyclic shift size of 0, an RSRP value between −2 dBm and −4 dBm may be mapped to cyclic shift size of 1, an RSRP value between −4 dBm and −6 dBm may be mapped to cyclic shift size of 2, an RSRP value between −6 dBm and −8 dBm may be mapped to cyclic shift size of 3, etc.

In accordance with some aspects, multiple CSI feedback parameters may be mapped to a sequence that is cyclically shifted. For example, a UE may wish to send a CSI report indicating SSBRI=1 and RSRP=−3 dBm for SSBRI 1 to a network entity (or receiving device). The UE may generate (or acquire a stored pre-generated copy of) a ZC sequence with a second root sequence index, u=2 (e.g., the second pre-generated waveform 804) and then may cyclically shift this ZC sequence with a cyclic shift size of 1 (e.g., the first cyclic shift size 824). The UE transmits the resulting waveform that communicates this CSI report to the network entity.

Other sequences, for example, those that generate CAZAC waveforms and/or have low threshold autocorrelation properties but lack constant amplitudes, may similarly apply some or all of the waveform construction techniques described herein. For example, using the techniques described herein, CSI feedback parameters may be similarly mapped in resulting waveforms based on Golomb polyphase sequences, Björck sequences, generalized chirp-like (GCL) sequences, Golay sequences, etc.

FIG. 9 depicts a second example 900 of a waveform construction technique that may be used by a UE (e.g., UE 704) to transmit waveforms. In some aspects, the CSI feedback signal may be a base signal that includes transmission parameters and concepts similar to OOK-1 and/or OOK-4 depicted and described with respect to FIG. 6.

A CSI feedback signal may be generated by mapping CSI feedback parameters to a set of subcarriers in the CSI feedback signal. That is, for example, each CSI feedback parameter may be mapped to a subcarrier of the set of subcarriers. In some examples, the total number of subcarriers in the CSI feedback signal may be partitioned into different sets of subcarriers for indicating specific CSI feedback parameters within a specific set of subcarriers.

For example, SSBRI parameters may be mapped to a first set of subcarriers 910. In some examples, SSBRI 0 may be mapped to a first subcarrier of the first set of subcarriers, SSBRI 1 may be mapped to a second subcarrier of the first set of subcarriers, SSBRI 2 may be mapped to a third subcarrier of the first set of subcarriers, . . . , and SSBRI 15 may be mapped to a sixteenth subcarrier of the first set of subcarriers.

Additionally, or alternatively, CRI parameters may be mapped to the first set of subcarriers 910. In some examples, CRI 0 may be mapped to the first subcarrier of the first set of subcarriers, CRI 1 may be mapped to the second subcarrier of the first set of subcarriers, CRI 2 may be mapped to the third subcarrier of the first set of subcarriers, . . . , and CRI 15 may be mapped to the sixteenth subcarrier of the first set of subcarriers. In some examples, SSBRI 0 may be mapped to the first subcarrier of the first set of subcarriers, SSBRI 1 may be mapped to the second subcarrier of the first set of subcarriers, . . . , SSBRI 15 may be mapped to the sixteenth subcarrier of the first set of subcarriers, CRI 0 may be mapped to a seventeenth subcarrier of the first set of subcarriers, CRI 1 may be mapped to an eighteenth subcarrier of the first set of subcarriers, . . . , and CRI 15 may be mapped to a thirty-second subcarrier of the first set of subcarriers 910.

To select or indicate a desired CSI parameter to feedback to a network entity (e.g., network entity 702, other receiving device, etc.), the UE may apply signal power to the subcarrier of the first set of subcarriers 910 that is mapped to the corresponding CSI parameter or value.

In some examples, RSRP parameters may be mapped to a second set of subcarriers 920. In some examples, the selected CSI parameter indication technique related to the second set of subcarriers 920 may be different from the selected CSI parameter indication technique used with respect to the first set of subcarriers 910.

For example, a number, n, of subcarriers in the second set of subcarriers 920 may provide a binary bit mapping to indicate the selected CSI parameter of a set of CSI parameters. For example, if the set of CSI parameters corresponds to RSRP parameters, and n=6, then 2″=64 possible RSRP values may be selected by using the binary bit mapping technique. For example, the binary bit mapping technique may include mapping a first subcarrier of the second set of subcarriers as a first (least significant) bit, a second subcarrier of the second set of subcarriers as a second bit, a third subcarrier of the second set of subcarriers as a third bit, a fourth subcarrier of the second set of subcarriers as a fourth bit, a fifth subcarrier of the second set of subcarriers as a fifth bit, and a sixth subcarrier of the second set of subcarriers as a sixth (most significant) bit.

In some examples, an RSRP value between 0 dBm and −2 dBm may be mapped to ‘000000’, an RSRP value between −2 dBm and −4 dBm may be mapped to ‘000001’, an RSRP value between −4 dBm and −6 dBm may be mapped to ‘000010’, an RSRP value between −6 dBm and −8 dBm may be mapped to ‘000011’, an RSRP value between −8 dBm and −10 dBm may be mapped to ‘000100’, an RSRP value between −10 dBm and −12 dBm may be mapped to ‘000101’, etc.

As depicted in FIG. 9, a UE may send a CSI report by generating a waveform based on a CSI feedback signal. For example, the UE may use an iFFT to generate a time-domain waveform by transforming the set of subcarriers (in the frequency domain) into a signal or waveform for transmission. In some aspects, the UE may use the iFFT to pre-generate waveforms. In one example, the CSI report may indicate SSBRI=2 and RSRP=−7 dBm for SSBRI 2 using a CSI feedback signal. The UE may generate (or acquire a stored pre-generated copy of) a CSI feedback signal by applying signal power (illustrated with ‘X’) to the third subcarrier in the first set of subcarriers 910 (e.g., the SSBRI 2 may be mapped to the third subcarrier of the first set of subcarriers), and also applying signal power (illustrated with ‘X’) to the first and second subcarriers of the second set of subcarriers 920 (e.g., the RSRP value between −6 dBm and −8 dBm may be mapped to binary value ‘000011’). The UE may refrain from applying signal power to the remaining subcarriers in the first set of subcarriers 910 and the second set of subcarriers 920).

As compared to other CSI reporting schemes, the network entity does not need to utilize DMRS techniques to determine what information is contained in the received signals generated by the waveform construction techniques described herein. For example, in some CSI reporting schemes, bits (e.g., indicating CSI parameters) may first be mapped to constellation points. These mapped constellation points may be used to modulate a signal for transmission. When the network entity tries to demodulate the signal to determine what bits are mapped to the received constellation points, the network entity references one or more DMRS, which are embedded in the transmitted signal. The network entity may know what DMRS transmitter will transmit and where in time/frequency DMRS will be embedded in the transmitted signal. In this manner, by comparing received DMRS with what DMRS should have been transmitted, the network entity can ascertain which received constellation points map to which bits. The waveforms transmissions in accordance with sequences described herein, there is no mapping of bits to constellation points. Accordingly, no DMRS are transmitted along with the information bearing signal.

### Example Operations of a User Equipment

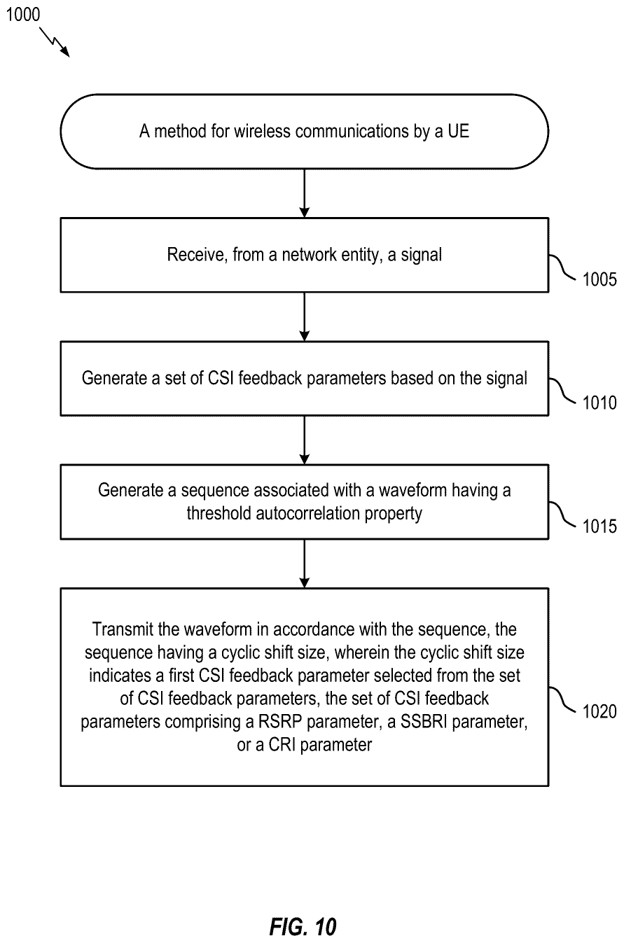

FIG. 10 shows a method 1000 for wireless communications by a UE, the UE capable of operating in a low-power transceiver mode, the method, such as UE 104 of FIG. 1 or UE 304 of FIG. 3.

Method 1000 begins at block 1005 with receiving, from a network entity, a signal, as illustrated for example at 706 of FIG. 7.

Method 1000 then proceeds to block 1010 with generating a set of CSI feedback parameters based on the signal.

Method 1000 then proceeds to block 1015 with generating a sequence associated with a waveform having a threshold autocorrelation property.

Method 1000 then proceeds to block 1020 with transmitting the waveform in accordance with the sequence, the sequence having a cyclic shift size, wherein the cyclic shift size indicates a first CSI feedback parameter selected from the set of CSI feedback parameters, the set of CSI feedback parameters comprising a RSRP parameter, a SSBRI parameter, or a CRI parameter, as illustrated for example at 708 of FIG. 7.

In some aspects, the sequence has a root sequence index indicating a second CSI feedback parameter selected from the set of CSI feedback parameters and is different from the first CSI feedback parameter, and block 1020 includes transmitting the waveform in accordance with the sequence, the sequence having the cyclic shift size and the root sequence index.

In some aspects, the first CSI feedback parameter is the RSRP parameter, and the second CSI feedback parameter is one of the SSBRI parameter or the CRI parameter.

In some aspects, the root sequence index of the sequence is selected from a set of root sequence indices; a first root sequence index of the set of root sequence indices corresponds to a first value of the SSBRI parameter; and a second root sequence index of the set of root sequence indices corresponds to a first value of the CRI parameter.

In some aspects, a third root sequence index of the set of root sequence indices corresponds to a second value of the SSBRI parameter; and a fourth root sequence index of the set of root sequence indices corresponds to a second value of the CRI parameter.

In some aspects, the cyclic shift size of the sequence is selected from a set of cyclic shift sizes; a first cyclic shift size of the set of cyclic shift sizes corresponds to a first value or range of values of the RSRP parameter; and a second cyclic shift size of the set of cyclic shift sizes corresponds to a second value or range of values of the RSRP parameter.

In some aspects, the sequence associated with the waveform having the threshold autocorrelation property is a Zadoff-Chu sequence.

In some aspects, the sequence associated with the waveform having the threshold autocorrelation property is a type of sequence that is capable of generating CAZAC waveforms.

In some aspects, the sequence associated with the waveform having the threshold autocorrelation property is an m-sequence.

In some aspects, the UE is operating in the low-power transceiver mode; the signal is a WUS; and the waveform is transmitted prior to performing a wake-up operation for a transceiver mode different from the low-power transceiver mode.

In some aspects, the low-power transceiver mode uses a first transceiver, and the transceiver mode uses a second transceiver different from the first transceiver.

In some aspects, the waveform that is transmitted in accordance with the sequence having the cyclic shift size is a first pre-generated waveform of a set of pre-generated waveforms stored in one or more memories of the UE.

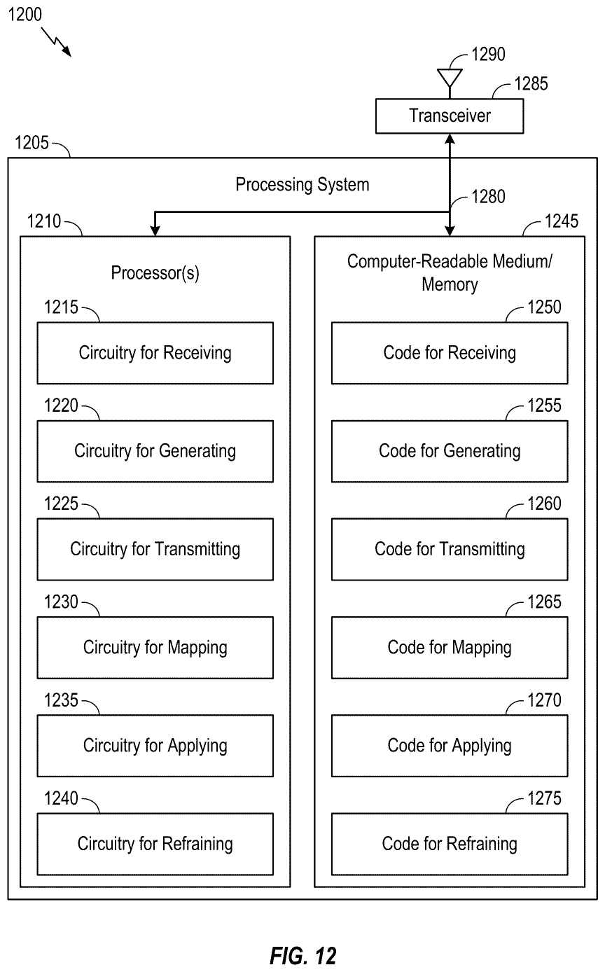

In some aspects, method 1000, or any aspect related to it, may be performed by an apparatus, such as communications device 1200 of FIG. 12, which includes various components operable, configured, or adapted to perform the method 1000.

Communications device 1200 is described below in further detail.

Note that FIG. 10 is just one example of a method, and other methods including fewer, additional, or alternative operations are possible consistent with this disclosure.

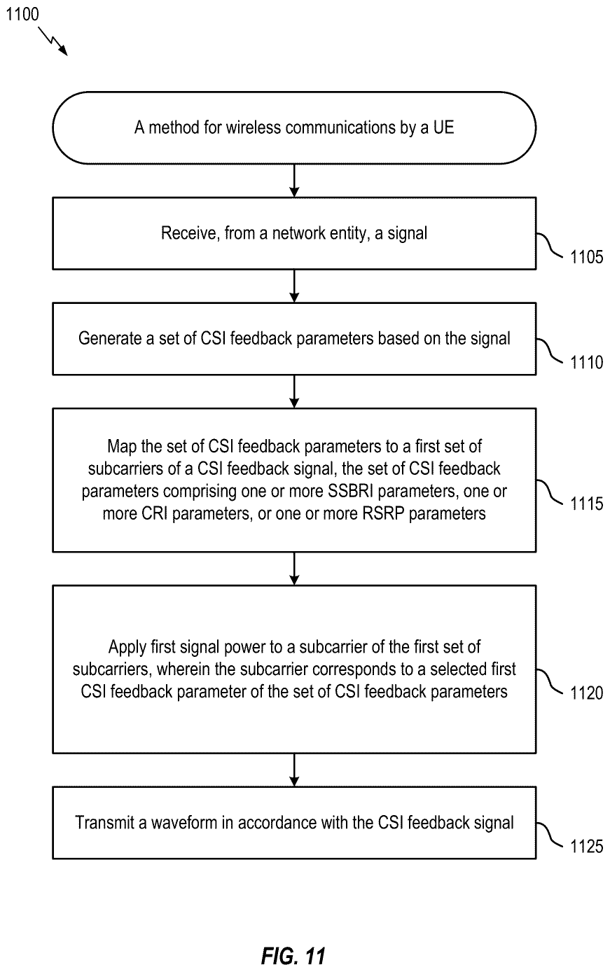

FIG. 11 shows a method 1100 for wireless communications by a UE, the UE capable of operating in a low-power transceiver mode, the method, such as UE 104 of FIG. 1 or UE 304 of FIG. 3.

Method 1100 begins at block 1105 with receiving, from a network entity, a signal, as illustrated for example at 706 of FIG. 7.

Method 1100 then proceeds to block 1110 with generating a set of CSI feedback parameters based on the signal.

Method 1100 then proceeds to block 1115 with mapping the set of CSI feedback parameters to a first set of subcarriers of a CSI feedback signal, the set of CSI feedback parameters comprising one or more SSBRI parameters, one or more CRI parameters, or one or more RSRP parameters.

Method 1100 then proceeds to block 1120 with applying first signal power to a subcarrier of the first set of subcarriers, wherein the subcarrier corresponds to a selected first CSI feedback parameter of the set of CSI feedback parameters.

Method 1100 then proceeds to block 1125 with transmitting a waveform in accordance with the CSI feedback signal, as illustrated for example at 708 of FIG. 7.

In some aspects, the set of CSI feedback parameters mapped to the first set of subcarriers of the CSI feedback signal comprises the one or more SSBRI parameters, the one or more CRI parameters, or both, and the method 1100 further comprises: mapping the one or more RSRP parameters to a second set of subcarriers of the CSI feedback signal; and applying second power to at least one subcarrier of the second set of subcarriers.

In some aspects, the at least one subcarrier corresponds to a selected RSRP parameter of the one or more RSRP parameters, and the selected RSRP parameter indicates a value or range of values for the selected first CSI feedback parameter.

In some aspects, the at least one subcarrier of the second set of subcarriers corresponds to a binary bit mapping of the one or more RSRP parameters.

In some aspects, method 1100 further includes refraining from applying signal power to one or more remaining subcarriers of the first set of subcarriers, wherein the one or more remaining subcarriers are different from the subcarrier of the first set of subcarriers.

In some aspects, the UE is operating in the low-power transceiver mode; the signal is a WUS; and the waveform is transmitted prior to performing a wake-up operation for a transceiver mode different from the low-power transceiver mode.

In some aspects, the waveform that is transmitted in accordance with the CSI feedback signal is a first pre-generated waveform of a set of pre-generated waveforms stored in one or more memories of the UE.

In some aspects, method 1100, or any aspect related to it, may be performed by an apparatus, such as communications device 1200 of FIG. 12, which includes various components operable, configured, or adapted to perform the method 1100. Communications device 1200 is described below in further detail.

Note that FIG. 11 is just one example of a method, and other methods including fewer, additional, or alternative operations are possible consistent with this disclosure.

### Example Communications Device

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1285 (e.g., a transmitter and/or a receiver). The transceiver 1285 is configured to transmit and receive signals for the communications device 1200 via an antenna 1290, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1245. In various aspects, the one or more processors 1210 may be representative of the one or more processors 318 described with respect to FIG. 3. The one or more processors 1210 are coupled to a computer-readable medium/memory 1245 via a bus 1280. In some aspects, the computer-readable medium/memory 1245 may be representative of the one or more memories 320 described with respect to FIG. 3. The computer-readable medium/memory 1245 is a non-transitory computer-readable medium/memory. In certain aspects, the computer-readable medium/memory 1245 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10; and the method 1100 described with respect to FIG. 11, or any aspect related to it, including any operations described in relation to FIG. 11. Note that reference to a processor performing a function of communications device 1200 may include one or more processors performing that function of communications device 1200, such as in a distributed fashion.

In the depicted example, computer-readable medium/memory 1245 stores code (e.g., executable instructions), including code for receiving 1250, code for generating 1255, code for transmitting 1260, code for mapping 1265, code for applying 1270, and code for refraining 1275. Processing of the code 1250-1275 may enable and cause the communications device 1200 to perform the method 1000 described with respect to FIG. 10, or any aspect related to it; and the method 1100 described with respect to FIG. 11, or any aspect related to it. For instance, code for receiving 1250 includes code for receiving, from a network entity, a signal. In some aspects, code for generating 1255 includes code for generating a set of CSI feedback parameters based on the signal. In some aspects, code for generating 1255 includes code for generating a sequence associated with a waveform having a threshold autocorrelation property. In some aspects, code for transmitting 1260 includes code for transmitting the waveform in accordance with the sequence, the sequence having a cyclic shift size, wherein the cyclic shift size indicates a first CSI feedback parameter selected from the set of CSI feedback parameters, the set of CSI feedback parameters comprising a RSRP parameter, a SSBRI parameter, or a CRI parameter.

For instance, code for receiving 1250 includes code for receiving, from a network entity, a signal. In some aspects, code for generating 1255 includes code for generating a set of CSI feedback parameters based on the signal. In some aspects, code for mapping 1265 includes code for mapping the set of CSI feedback parameters to a first set of subcarriers of a CSI feedback signal, the set of CSI feedback parameters comprising one or more SSBRI parameters, one or more CRI parameters, or one or more RSRP parameters. In some aspects, code for applying 1270 includes code for applying first signal power to a subcarrier of the first set of subcarriers, wherein the subcarrier corresponds to a selected first CSI feedback parameter of the set of CSI feedback parameters. In some aspects, code for transmitting 1260 includes code for transmitting a waveform in accordance with the CSI feedback signal.

The one or more processors 1210 include circuitry configured to implement (e.g., execute) the code stored in the computer-readable medium/memory 1245, including circuitry for receiving 1215, circuitry for generating 1220, circuitry for transmitting 1225, circuitry for mapping 1230, circuitry for applying 1235, and circuitry for refraining 1240. Processing with circuitry 1215-1240 may enable and cause the communications device 1200 to perform the method 1000 described with respect to FIG. 10, or any aspect related to it; and the method 1100 described with respect to FIG. 11, or any aspect related to it. For instance, circuitry for receiving 1215 includes circuitry for receiving, from a network entity, a signal. In some aspects, circuitry for generating 1220 includes circuitry for generating a set of CSI feedback parameters based on the signal. In some aspects, circuitry for generating 1220 includes circuitry for generating a sequence associated with a waveform having a threshold autocorrelation property. In some aspects, circuitry for transmitting 1225 includes circuitry for transmitting the waveform in accordance with the sequence, the sequence having a cyclic shift size, wherein the cyclic shift size indicates a first CSI feedback parameter selected from the set of CSI feedback parameters, the set of CSI feedback parameters comprising a RSRP parameter, a SSBRI parameter, or a CRI parameter.

For instance, circuitry for receiving 1215 includes circuitry for receiving, from a network entity, a signal. In some aspects, circuitry for generating 1220 includes circuitry for generating a set of CSI feedback parameters based on the signal. In some aspects, circuitry for mapping 1230 includes circuitry for mapping the set of CSI feedback parameters to a first set of subcarriers of a CSI feedback signal, the set of CSI feedback parameters comprising one or more SSBRI parameters, one or more CRI parameters, or one or more RSRP parameters. In some aspects, circuitry for applying 1235 includes circuitry for applying first signal power to a subcarrier of the first set of subcarriers, wherein the subcarrier corresponds to a selected first CSI feedback parameter of the set of CSI feedback parameters. In some aspects, circuitry for transmitting 1225 includes circuitry for transmitting a waveform in accordance with the CSI feedback signal.

More generally, means for communicating, transmitting, sending or outputting for transmission may include the one or more transceivers 324, one or more antenna 322 and/or processing system 316 of the UE 304 illustrated in FIG. 3, transceiver 1285 and/or antenna 1290 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1285 and/or antenna 1290 of the communications device 1200 in FIG. 12, and/or one or more processors 1210 of the communications device 1200 in FIG. 12.

### Example Clauses

Implementation examples are described in the following numbered clauses:

Clause 1: A method for wireless communications by a UE, the UE capable of operating in a low-power transceiver mode, the method comprising: receiving, from a network entity, a signal; generating a set of CSI feedback parameters based on the signal; generating a sequence associated with a waveform having a threshold autocorrelation property; and transmitting the waveform in accordance with the sequence, the sequence having a cyclic shift size, wherein the cyclic shift size indicates a first CSI feedback parameter selected from the set of CSI feedback parameters, the set of CSI feedback parameters comprising a RSRP parameter, a SSBRI parameter, or a CRI parameter.

Clause 2: The method of Clause 1, wherein: the sequence has a root sequence index indicating a second CSI feedback parameter selected from the set of CSI feedback parameters and is different from the first CSI feedback parameter, and transmitting the waveform comprises transmitting the waveform in accordance with the sequence, the sequence having the cyclic shift size and the root sequence index.

Clause 3: The method of Clause 2, wherein the first CSI feedback parameter is the RSRP parameter, and the second CSI feedback parameter is one of the SSBRI parameter or the CRI parameter.

Clause 4: The method of Clause 2, wherein: the root sequence index of the sequence is selected from a set of root sequence indices; a first root sequence index of the set of root sequence indices corresponds to a first value of the SSBRI parameter; and a second root sequence index of the set of root sequence indices corresponds to a first value of the CRI parameter.

Clause 5: The method of Clause 4, wherein: a third root sequence index of the set of root sequence indices corresponds to a second value of the SSBRI parameter; and a fourth root sequence index of the set of root sequence indices corresponds to a second value of the CRI parameter.

Clause 6: The method of any one of Clauses 1-5, wherein: the cyclic shift size of the sequence is selected from a set of cyclic shift sizes; a first cyclic shift size of the set of cyclic shift sizes corresponds to a first value or range of values of the RSRP parameter; and a second cyclic shift size of the set of cyclic shift sizes corresponds to a second value or range of values of the RSRP parameter.

Clause 7: The method of any one of Clauses 1-6, wherein the sequence associated with the waveform having the threshold autocorrelation property is a Zadoff-Chu sequence.

Clause 8: The method of any one of Clauses 1-7, wherein the sequence associated with the waveform having the threshold autocorrelation property is a type of sequence that is capable of generating CAZAC waveforms.

Clause 9: The method of any one of Clauses 1-8, wherein the sequence associated with the waveform having the threshold autocorrelation property is an m-sequence.

Clause 10: The method of any one of Clauses 1-9, wherein: the UE is operating in the low-power transceiver mode; the signal is a WUS; and the waveform is transmitted prior to performing a wake-up operation for a transceiver mode different from the low-power transceiver mode, or further comprising: monitoring for the WUS while the UE is operating in the low-power transceiver mode, wherein the waveform is transmitted in the low-power transceiver mode without performing a wake-up operation for a transceiver mode different from the low-power transceiver mode.

Clause 11: The method of Clause 10, wherein the low-power transceiver mode uses a first transceiver, and the transceiver mode uses a second transceiver different from the first transceiver.

Clause 12: The method of any one of Clauses 1-11, wherein the waveform that is transmitted in accordance with the sequence having the cyclic shift size is a first pre-generated waveform of a set of pre-generated waveforms stored in one or more memories of the UE.

Clause 13: A method for wireless communications by a UE, the UE capable of operating in a low-power transceiver mode, the method comprising: receiving, from a network entity, a signal; generating a set of CSI feedback parameters based on the signal; mapping the set of CSI feedback parameters to a first set of subcarriers of a CSI feedback signal, the set of CSI feedback parameters comprising one or more SSBRI parameters, one or more CRI parameters, or one or more RSRP parameters; applying first signal power to a subcarrier of the first set of subcarriers, wherein the subcarrier corresponds to a selected first CSI feedback parameter of the set of CSI feedback parameters; and transmitting a waveform in accordance with the CSI feedback signal.

Clause 14: The method of Clause 13, wherein the set of CSI feedback parameters mapped to the first set of subcarriers of the CSI feedback signal comprises the one or more SSBRI parameters, the one or more CRI parameters, or both, and the method further comprises: mapping the one or more RSRP parameters to a second set of subcarriers of the CSI feedback signal; and applying second power to at least one subcarrier of the second set of subcarriers.

Clause 15: The method of Clause 14, wherein: the at least one subcarrier corresponds to a selected RSRP parameter of the one or more RSRP parameters, and the selected RSRP parameter indicates a value or range of values for the selected first CSI feedback parameter.

Clause 16: The method of Clause 14, wherein the at least one subcarrier of the second set of subcarriers corresponds to a binary bit mapping of the one or more RSRP parameters.

Clause 17: The method of any one of Clauses 13-16, further comprising: refraining from applying signal power to one or more remaining subcarriers of the first set of subcarriers, wherein the one or more remaining subcarriers are different from the subcarrier of the first set of subcarriers.

Clause 18: The method of any one of Clauses 13-17, wherein: the UE is operating in the low-power transceiver mode; the signal is a WUS; and the waveform is transmitted prior to performing a wake-up operation for a transceiver mode different from the low-power transceiver mode.

Clause 19: The method of any one of Clauses 13-18, wherein the waveform that is transmitted in accordance with the CSI feedback signal is a first pre-generated waveform of a set of pre-generated waveforms stored in one or more memories of the UE.

Clause 20: One or more apparatuses, comprising: one or more memories comprising executable instructions; and one or more processors configured to execute the executable instructions and cause the one or more apparatuses to perform a method in accordance with any one of Clauses 1-19.

Clause 21: One or more apparatuses configured for wireless communications, comprising: one or more memories; and one or more processors, coupled to the one or more memories, configured to cause the one or more apparatuses to perform a method in accordance with any one of Clauses 1-19.

Clause 22: One or more apparatuses configured for wireless communications, comprising: one or more memories; and one or more processors, coupled to the one or more memories, configured to perform a method in accordance with any one of Clauses 1-19.

Clause 23: One or more apparatuses, comprising means for performing a method in accordance with any one of Clauses 1-19.

Clause 24: One or more non-transitory computer-readable media comprising executable instructions that, when executed by one or more processors of one or more apparatuses, cause the one or more apparatuses to perform a method in accordance with any one of Clauses 1-19.

Clause 25: One or more computer program products embodied on one or more computer-readable storage media comprising code for performing a method in accordance with any one of Clauses 1-19.

Clause 26: One or more apparatuses configured for wireless communications, comprising: a processing system that includes one or more processors and one or more memories coupled with the one or more processors, the processing system configured to cause the one or more apparatuses to perform a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. A user equipment (UE) capable of operating in a low-power transceiver mode, the UE comprising a processing system that includes one or more processors and one or more memories coupled with the one or more processors, the processing system configured to cause the UE to:
receive, from a network entity, a signal;
generate a set of channel state information (CSI) feedback parameters based on the signal;
generate a sequence associated with a waveform having a threshold autocorrelation property; and
transmit the waveform in accordance with the sequence, the sequence having a cyclic shift size, wherein the cyclic shift size indicates a first CSI feedback parameter selected from the set of CSI feedback parameters, the set of CSI feedback parameters comprising a reference signal received power (RSRP) parameter, a synchronization signal/physical broadcast channel (SS/PBCH) block resource indicator (SSBRI) parameter, or a CSI reference signal resource indicator (CRI) parameter.

2. The UE of claim 1, wherein:
the sequence has a root sequence index indicating a second CSI feedback parameter selected from the set of CSI feedback parameters and is different from the first CSI feedback parameter, and
to cause the UE to transmit the waveform, the processing system is configured to cause the UE to transmit the waveform in accordance with the sequence, the sequence having the cyclic shift size and the root sequence index.

3. The UE of claim 2, wherein the first CSI feedback parameter is the RSRP parameter, and the second CSI feedback parameter is one of the SSBRI parameter or the CRI parameter.

4. The UE of claim 2, wherein:
the root sequence index of the sequence is selected from a set of root sequence indices;
a first root sequence index of the set of root sequence indices corresponds to a first value of the SSBRI parameter; and
a second root sequence index of the set of root sequence indices corresponds to a first value of the CRI parameter.

5. The UE of claim 4, wherein:
a third root sequence index of the set of root sequence indices corresponds to a second value of the SSBRI parameter; and
a fourth root sequence index of the set of root sequence indices corresponds to a second value of the CRI parameter.

6. The UE of claim 1, wherein:
the cyclic shift size of the sequence is selected from a set of cyclic shift sizes;
a first cyclic shift size of the set of cyclic shift sizes corresponds to a first value or range of values of the RSRP parameter; and
a second cyclic shift size of the set of cyclic shift sizes corresponds to a second value or range of values of the RSRP parameter.

7. The UE of claim 1, wherein the sequence associated with the waveform having the threshold autocorrelation property is a Zadoff-Chu sequence.

8. The UE of claim 1, wherein the sequence associated with the waveform having the threshold autocorrelation property is a type of sequence that is capable of generating constant amplitude zero autocorrelation (CAZAC) waveforms.

9. The UE of claim 1, wherein the sequence associated with the waveform having the threshold autocorrelation property is an m-sequence.

10. The UE of claim 1, wherein the processing system is further configured to cause the UE to:
operate in the low-power transceiver mode, and wherein:
the signal is a wake-up signal (WUS); and
the waveform is transmitted prior to performing a wake-up operation for a transceiver mode different from the low-power transceiver mode, or
monitor for the WUS while the UE is operating in the low-power transceiver mode, wherein the waveform is transmitted in the low-power transceiver mode without performing a wake-up operation for a transceiver mode different from the low-power transceiver mode.

11. The UE of claim 10, wherein the low-power transceiver mode uses a first transceiver, and the transceiver mode uses a second transceiver different from the first transceiver.

12. The UE of claim 1, wherein the waveform that is transmitted in accordance with the sequence having the cyclic shift size is a first pre-generated waveform of a set of pre-generated waveforms stored in the one or more memories of the UE.

13. A user equipment (UE) capable of operating in a low-power transceiver mode, the UE comprising a processing system that includes one or more processors and one or more memories coupled with the one or more processors, the processing system configured to cause the UE to:
receive, from a network entity, a signal;
generate a set of CSI feedback parameters based on the signal;
map the set of CSI feedback parameters to a first set of subcarriers of a CSI feedback signal, the set of CSI feedback parameters comprising one or more synchronization signal/physical broadcast channel (SS/PBCH) block resource indicator (SSBRI) parameters, one or more CSI reference signal resource indicator (CRI) parameters, or one or more reference signal received power (RSRP) parameters;
apply first signal power to a subcarrier of the first set of subcarriers, wherein the subcarrier corresponds to a selected first CSI feedback parameter of the set of CSI feedback parameters; and
transmit a waveform in accordance with the CSI feedback signal.

14. The UE of claim 13, wherein the set of CSI feedback parameters mapped to the first set of subcarriers of the CSI feedback signal comprises the one or more SSBRI parameters, the one or more CRI parameters, or both, and the processing system is configured to cause the UE to:
map the one or more RSRP parameters to a second set of subcarriers of the CSI feedback signal; and
apply second power to at least one subcarrier of the second set of subcarriers.

15. The UE of claim 14, wherein:
the at least one subcarrier corresponds to a selected RSRP parameter of the one or more RSRP parameters, and
the selected RSRP parameter indicates a value or range of values for the selected first CSI feedback parameter.

16. The UE of claim 14, wherein the at least one subcarrier of the second set of subcarriers corresponds to a binary bit mapping of the one or more RSRP parameters.

17. The UE of claim 13, wherein the processing system is configured to cause the UE to:
refrain from applying signal power to one or more remaining subcarriers of the first set of subcarriers, wherein the one or more remaining subcarriers are different from the subcarrier of the first set of subcarriers.

18. The UE of claim 13, wherein the processing system is further configured to cause the UE to:
operate in the low-power transceiver mode, and wherein:
the signal is a wake-up signal (WUS); and
the waveform is transmitted prior to performing a wake-up operation for a transceiver mode different from the low-power transceiver mode.

19. The UE of claim 13, wherein the waveform that is transmitted in accordance with the CSI feedback signal is a first pre-generated waveform of a set of pre-generated waveforms stored in the one or more memories of the UE.

20. A method for wireless communications by a user equipment (UE), the UE capable of operating in a low-power transceiver mode, the method comprising:
receiving, from a network entity, a signal;
generating a set of channel state information (CSI) feedback parameters based on the signal;
generating a sequence associated with a waveform having a threshold autocorrelation property; and
transmitting the waveform in accordance with the sequence, the sequence having a cyclic shift size, wherein the cyclic shift size indicates a first CSI feedback parameter selected from the set of CSI feedback parameters, the set of CSI feedback parameters comprising a reference signal received power (RSRP) parameter, a synchronization signal/physical broadcast channel (SS/PBCH) block resource indicator (SSBRI) parameter, or a CSI reference signal resource indicator (CRI) parameter.
